(19) United States
(12) Patent Application Publication
(10) Pub. No.: US 2014/0209342 A1
(43) Pub. Date: Jul. 31, 2014

(54) PNEUMATIC HAND TOOL

(71) Applicant: Sunmatch Industrial Co., Ltd., Zhubei City (TW)

(72) Inventor: Lung-Pao CHEN, Zhubei City (TW)

(73) Assignee: Sunmatch Industrial Co., Ltd., Zhubei City (TW)

(21) Appl. No.: 14/013,510

(22) Filed: Aug. 29, 2013

(30) Foreign Application Priority Data
Jan. 28, 2013 (TW) 102103053

(51) Int. Cl. B25F 5/02; B25B 21/00

(52) U.S. Cl. CPC B25F 5/02; B25B 21/00
USPC 173/218

(57) ABSTRACT

A pneumatic hand tool comprises a housing, a pneumatic motor held in the housing and an airflow regulation valve to control spinning direction of the pneumatic motor. The housing includes a handgrip and a holding portion connected to the handgrip. The handgrip has an airflow passage to receive driving airflow. The holding portion has a housing chamber to house the pneumatic motor and airflow regulation valve, and also has a first wall opposing the handgrip and a flow channeling chamber integrally extended from the first wall towards the housing chamber. The flow channeling chamber has a first directing vent located on the first wall and communicated with the airflow passage to receive the driving airflow and a second directing vent communicated with the airflow regulation valve to output the driving airflow to drive the pneumatic motor.

### FIELD OF THE INVENTION

The present invention relates to a pneumatic hand tool and particularly to a pneumatic hand tool that has an integrated flow channeling chamber in a housing to direct driving airflow.

### BACKGROUND OF THE INVENTION

With continuous progress of pneumatic hand tools the conventional pneumatic hand tools that adopt a three-stage housing for air intake have gradually being replaced by those adopted a two-stage housing for air intake. Examples of the pneumatic hand tool that adopts two-stage housing air intake can be found in R.O.C. patent Nos. 569885 and M416529. The present pneumatic hand tool that adopts the two-stage housing air intake usually has two cases to hold various structural elements and a pneumatic motor and a motor forward and reverse spinning regulation means integrated to form a single drive assembly to simplify assembly and structural complexity.

In addition, the two-stage housing air intake pneumatic hand tool also eliminates the air intake passage located on the case of the three-stage housing air intake, and has an air intake passage integrally extended from the pneumatic motor to the outer case, such as R.O.C. patent 1318914 which has a pneumatic motor with an air intake passage connected to a flow channeling passage formed on a handgrip, and a high pressure airflow generation means to receive driving airflow to drive the pneumatic motor. However, the pneumatic motor of the present pneumatic hand tool usually is made of metal. During fabrication of the air intake passage the pneumatic motor has to go through multiple machining processes. The structural elements of the pneumatic hand tool have to be matched accurately to maintain desired airtight effect without causing air leakage. Hence during fabrication of the pneumatic motor a great deal of attention has to be paid constantly to the dimensional specifications of the air intake passage to make sure that they match the design to avoid producing errors when finished that might otherwise cause ill fitting or coupling with the housing and result in deficiency airtight effect. All this makes fabrication more difficult and production cost higher.

### SUMMARY OF THE INVENTION

The primary object of the present invention is overcome fabrication problems incurred by the structure of the conventional pneumatic hand tools.

To achieve the foregoing object the present invention provides a pneumatic hand tool that comprises a housing, a pneumatic motor held in the housing and an airflow regulation valve to control spinning direction of the pneumatic motor. The housing includes a handgrip and a holding portion connected to the handgrip. The handgrip has an airflow passage to receive driving airflow. The holding portion has a housing chamber to house the pneumatic motor and airflow regulation valve. The invention provides features as follows: the holding portion includes a first wall opposing the handgrip and a flow channeling chamber integrally extended from the first wall towards the housing chamber. The flow channeling chamber has a first directing vent located on the first wall and communicated with the airflow passage to receive the driving airflow and a second directing vent communicated with the airflow regulation valve to output the driving airflow to the airflow regulation valve and drive the pneumatic motor spinning.

In one embodiment the holding portion includes a first case connected to the handgrip and a second case connected to the first case. Furthermore, the flow channeling chamber is located in the first case and includes an opening corresponding to one end of the second case. The first case has a second wall opposing another end of the second case. The second wall has an operation hole to allow users to operate the airflow regulation valve in the housing chamber. The flow channeling chamber has a closed portion formed by extending integrally from the second wall to seal another end thereof opposing the opening. In addition, the pneumatic hand tool further includes an airtight gasket clamped between the first case and second case. The airtight gasket has a sealing protrusion connected to and sealed the opening. Moreover, the first case has an end opening corresponding and connecting to one end of the second case. The airtight gasket has a wedge portion extended towards the first case to wedge in the end opening.

In another embodiment the second case is made of metal, and the first case can be made from a composite material.

In yet another embodiment the flow channeling chamber to includes a top wall in parallel with the first wall to separate the airflow regulation valve. The top wall contains the second directing vent.

The pneumatic hand tool, compared with the conventional pneumatic hand tool, has simpler fabrication. The pneumatic hand tool of the invention has the flow channeling chamber integrally formed with the holding portion. Compared with the pneumatic motor of the conventional pneumatic hand tool that requires multiple machining processes to form the air intake passage, the invention is much simpler in fabrication. In addition, the flow channeling chamber of the invention is formed by integrally extended from the holding portion. Through the second directing vent the driving airflow can be output to the airflow regulation valve, Compared with the conventional pneumatic hand tool that needs to form the air intake passage at the bottom end of the pneumatic motor to receive the driving airflow, this invention overcomes the unfit coupling and sealing problem between the structural elements of the pneumatic hand tool without causing air leakage.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of an embodiment of the pneumatic hand tool of the invention seen from a first visual angle.

FIG. 2 is an exploded view of an embodiment of the pneumatic hand tool of the invention seen from a second visual angle.

FIG. 3 is a sectional view of an embodiment of the pneumatic hand tool of the invention.

### DETAILED DESCRIPTION OF THE PREFERRED EMBODIMENT

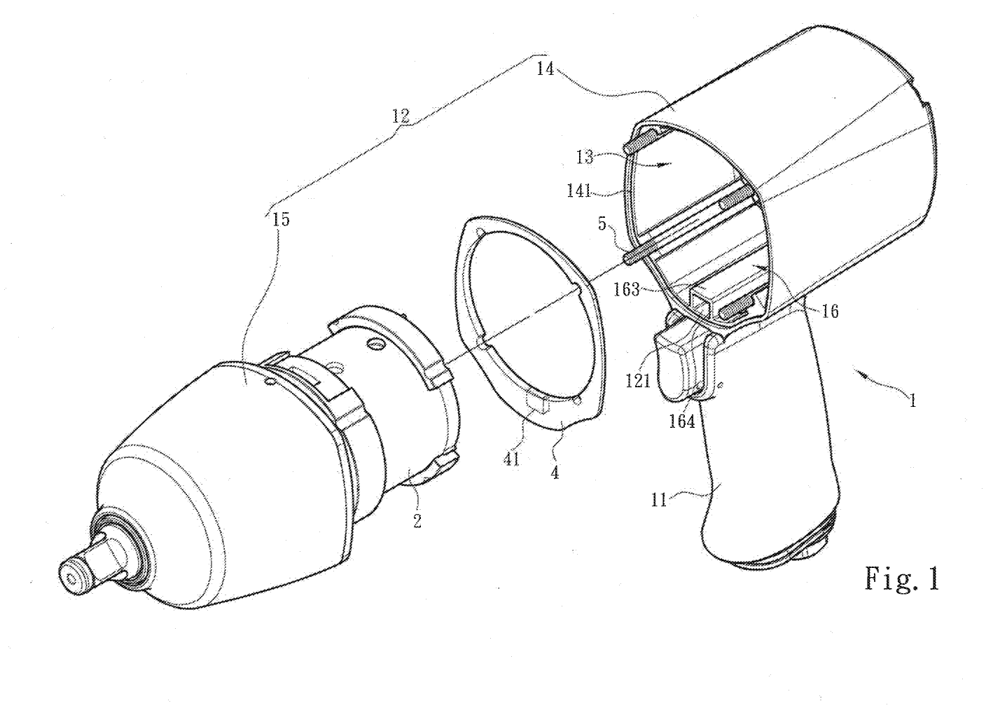

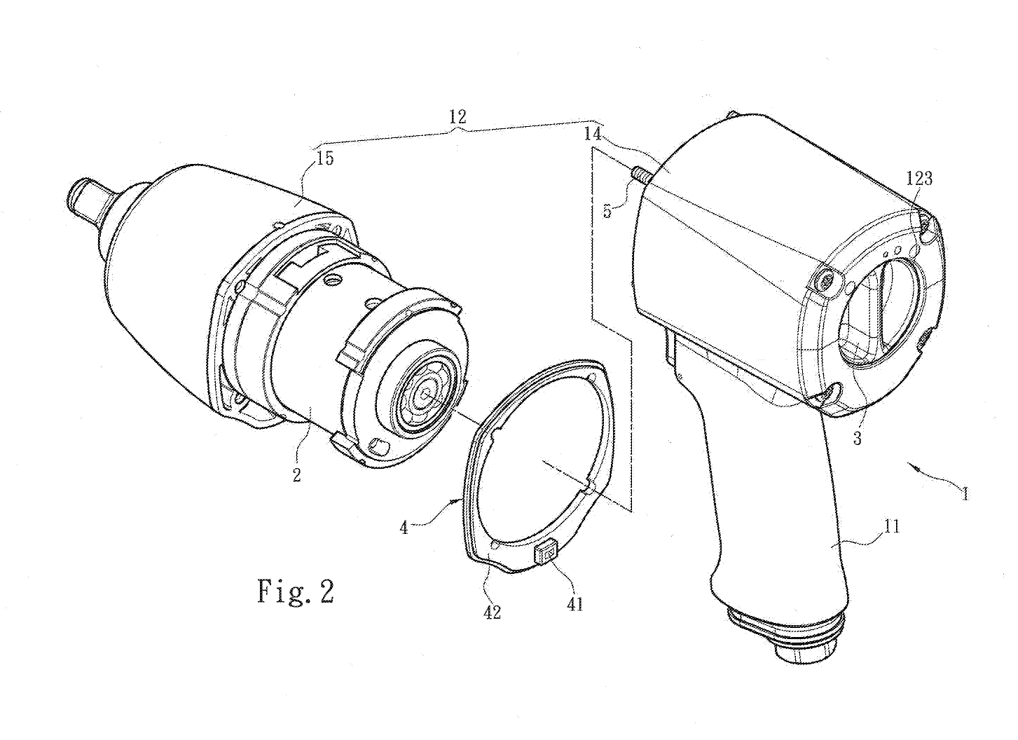

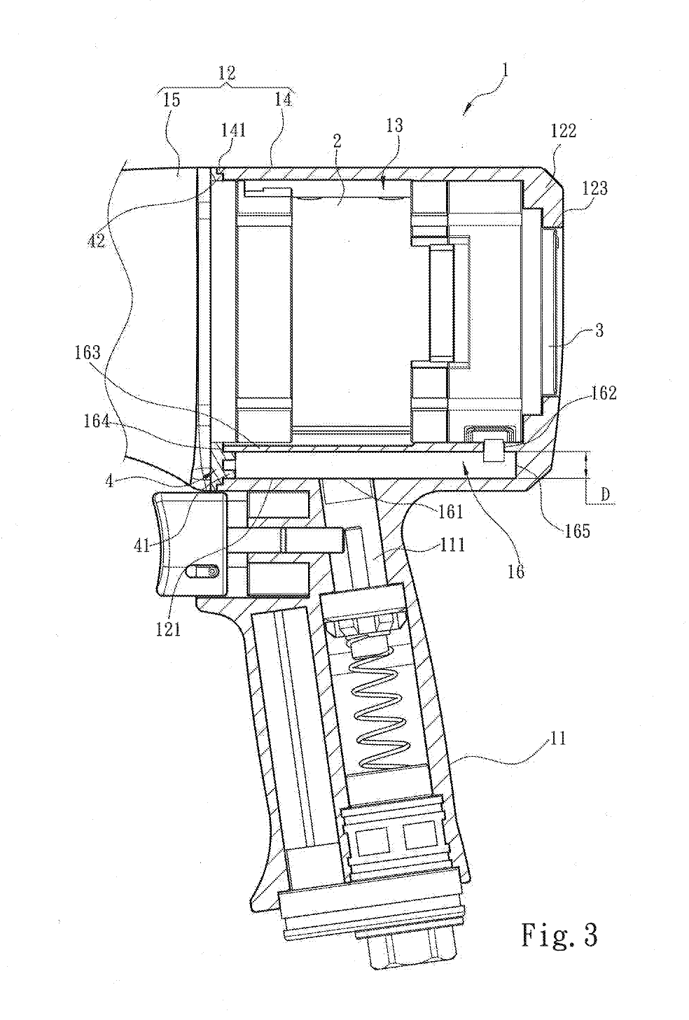

Please referring to FIGS. 1, 2 and 3, the present invention aims to provide a pneumatic hand tool that comprises a housing 1, a pneumatic motor 2 and an airflow regulation valve 3 to control spinning direction of the pneumatic motor 2. The housing 1 includes a handgrip 11 and a holding portion 12 connected to the handgrip 11. The handgrip 11 has an airflow passage 111 to receive driving airflow. The holding portion 12 has a housing chamber 13 to house the pneumatic motor 2 and airflow regulation valve 3. More specifically, the holding portion 12 includes a first case 14 connected to the handgrip 11 and a second case 15 connected to the first case 14 to form the housing chamber 13. The second case 15 can be made of metal, while the first case 14 can be made from a composite material. The holding portion 12 has a first wall 121 opposing the handgrip 11 and a second wall 122 opposing another end of the second case 15. Furthermore, the holding portion 12 has a flow channeling chamber 16 integrally formed by extending from the first wall 121 towards the housing chamber 13. The flow channeling chamber 16 has a first directing vent 161 formed on the first wall 121 and communicated with the airflow passage 111 to receive the driving airflow, and a second directing vent 162 communicated with the airflow regulation valve 3 to output the driving airflow to the airflow regulation valve 3 to drive the pneumatic motor 2 spinning. In addition, the flow channeling chamber 16 has a top wall 163 in parallel with the first wall 121 to separate the airflow regulation valve 3. The top wall 163 is spaced from the first wall 121 at an interval D to allow the driving airflow to flow therein. The top wall 163 has the second directing vent 162 formed thereon. Moreover, the flow channeling chamber 16 has a closed portion 165 formed by integrally extended from the second wall 122 to seal another end of the flow channeling chamber 16 opposite to the opening. The flow channeling chamber 16 is formed integrally with the holding portion 12 in a shape adjustable according to corresponding embodiments of each pneumatic hand tool, hence is not limited by the example shown in the drawings. In addition, the airflow regulation valve 3 is abutting the second wall 122 of the housing chamber 13. The second wall 122 further has an operation hole 123 to allow users to operate the air flow regulation valve 3 held in the housing chamber 13, thereby control forward or reverse spinning of the pneumatic motor 2. After the driving airflow enters the handgrip 11 through the airflow passage 111, it passes through the first directing vent 161 and enters the flow channeling chamber 16, and is channeled by the flow channeling chamber 16, and finally is output through the second directing vent 162 and enters the airflow regulation valve 3 as the driving source to drive the pneumatic motor 2.

Also referring to FIGS. 1 through 3 again, the flow channeling chamber 16 is integrally formed and extended from the holding portion 12, or more specifically, can be integrally formed with the first case 14. The flow channeling chamber 16 also can be made from the composite material by injection as the first case 14 does. The first case 14 has an end opening 141 at one end, and the flow channeling chamber 16 has an opening 164 corresponding to one end of the second case 15. Moreover, the pneumatic hand tool of the invention further has an airtight gasket 4 clamped between the first case 14 and second case 15 to generate deformation so that the first case 14 and second case 15 can be coupled tightly in an airtight fashion after assembly. Furthermore, the airtight gasket 4 has a sealing protrusion 41 to plug and seal the opening 164, thereby directs the driving airflow entered t he flow channeling chamber 16 to flow only towards the second directing vent 162. in addition, the airtight gasket 4 can further has a wedge portion 42 extended towards the first case 14 to be wedged in the end opening 141. The wedge portion 42 can retain the airtight gasket 4 during assembly, and also enhance airtight effect between the first case 14 and second case 15. The airtight gasket 4 can be made from a flexible material such as rubber. Furthermore, the first case 14 and second case 15 can be coupled together through a fastening element 5 such as a screw.

As a conclusion, the pneumatic hand tool of the invention provides features as follows: the holding portion of the housing has a first wall opposing the handgrip and a flow channeling chamber integrally formed and extended from the first wall towards the housing chamber; the flow channeling chamber has a first directing vent formed on the first wall and communicated with the airflow passage to receive the driving airflow and a second directing vent communicated with the airflow regulation valve to output the driving airflow. Namely, the flow channeling chamber is integrally formed and extended from the housing to direct the driving airflow to enter the airflow regulation valve to drive the pneumatic motor. Hence it overcomes the problem of complex fabrication process occurred to the conventional pneumatic hand tool that has the air intake passage formed on the driving motor to receive the driving airflow.

What is claimed is:

1. A pneumatic hand tool, comprising:
a housing including a handgrip and a holding portion connected to the handgrip, the handgrip including an airflow passage to receive driving airflow, the holding portion including a housing chamber to house the pneumatic motor and the airflow regulation valve, the holding portion including a first wall opposing the handgrip and a flow channeling chamber integrally extended from the first wall towards the housing chamber;
a pneumatic motor located in the housing chamber of the housing; and
an airflow regulation valve to control spinning direction of the pneumatic motor, the airflow regulation valve located in the housing chamber of the housing;
wherein the flow channeling chamber includes a first directing vent formed on the first wall and communicated with the airflow passage to receive the driving airflow and a second directing vent communicated with the airflow regulation valve to output the driving airflow to the airflow regulation valve to drive the pneumatic motor spinning.

2. The pneumatic hand tool of claim 1, wherein the holding portion includes a first case connected to the handgrip and a second case connected to the first case.

3. The pneumatic hand tool of claim 2, wherein the flow channeling chamber is located in the first case and includes an opening corresponding to one end of the second case.

4. The pneumatic hand tool of claim 3, wherein the first case includes a second wall opposing another end of the second case, the second wall including an operation hole to allow users to operate the airflow regulation valve held in the housing chamber, the flow channeling chamber containing a closed portion extended integrally from the second wall to seal another end of the flow channeling chamber opposing the opening.

5. The pneumatic hand tool of claim 3 including an airtight gasket clamped between the first case and the second case, the airtight gasket including a sealing protrusion to plug and seal the opening.

6. The pneumatic hand tool of claim 5, wherein the first case includes an end opening corresponding to and connected to one end of the second case, the airtight gasket containing a wedge portion extended towards the first case and wedged in the end opening.

7. The pneumatic hand tool of claim 2, wherein the second case is made of metal.

8. The pneumatic hand tool of claim 2, wherein the first case is made from a composite material.

9. The pneumatic hand tool of claim 1, wherein the :flow channeling chamber includes a top wall which is parallel with the first wall to separate the airflow regulation valve and includes the second directing vent.
